(19) United States
(12) Patent Application Publication
(10) Pub. No.: US 2017/0113483 A1
(43) Pub. Date: Apr. 27, 2017

(54) Multifunction Pen

(71) Applicant: Alice Cai, Fayetteville, AR (US)

(72) Inventor: Alice Cai, Fayetteville, AR (US)

(21) Appl. No.: 14/982,118

(22) Filed: Dec. 29, 2015

Related U.S. Application Data
(60) Provisional application No. 62/245,994, filed on Oct. 24, 2015.

(51) Int. Cl. B43K 24/12; B43K 23/08; B43K 29/02; B43K 8/02; B43K 21/00

(52) U.S. Cl. CPC B43K 24/12; B43K 8/02; B43K 21/006; B43K 29/02; B43K 23/08

(57) ABSTRACT

The present invention relates to a multifunction pen. It integrates the function of a pen, a mechanical pencil, and a highlighter into a single pen body. A user can use it as a pen, a mechanical pencil, or a highlighter as he or she wishes by simply sliding function buttons near one end of the pen body. The unique seal structure of the present invention prevents the highlighter from drying out when the multifunction pen is not in use, which prolongs the lifespan of the highlighter.

### BACKGROUND OF THE INVENTION

1. Field of the Invention

The present invention generally relates to a writing tool, and more particularly relates to a multifunction pen.

2. Description of Prior Arts

Pens, pencils, and color highlighters are widely used writing and marking tools. Although they have been well developed, there are still some issues related to these tools. For example, a highlighter contains some volatile substance that continuously evaporates through the tip of the highlighter. To prevent such evaporation, a cap is used to cover the tip of a highlighter. A user needs to remove the cap when he or she wants to use the highlighter. It is quite common that a user misplaces the cap and cannot find it when he or she wants to cover the highlighter with the cap. This leaves the tip of the highlighter in open air, which reduces lifespan of the highlighter. Another issue with existing writing tools is that a user has to have several individual devices when he or she needs to use a pen, a pencil, and a highlighter. That is not very convenient.

To solve the above problems, the present invention, a multifunction pen, is invented. A user does not need to track the cap of a highlighter, and the user can have one pen body that has functions of a pencil, a pen, and a highlighter.

### SUMMARY OF THE INVENTION

The present invention relates to a multifunction pen. It integrates the functions of a pen, a mechanical pencil, and a highlighter into a single pen body. A user can use it as a pen, a mechanical pencil, or a highlighter as he or she wishes by simply sliding the function buttons near one end of the pen body.

The pen body of the present invention has two sections: an upper section and a lower section. One of the functions of the upper section is to host the elements that control the movement and selection of the function. One of the functions of the lower section is to seal a pen, a pencil, and a highlighter in an enclosure to prevent volatile substance of the highlighter from evaporating. This prolongs the lifespan of the highlighter.

The present invention offers various advantages. Firstly, it enables a person to use a single device as a pen, a pencil, and a highlighter. Secondly, it can easily seal a highlighter inside the pen body to prevent a color highlighter from drying out.

### BRIEF DESCRIPTION OF THE DRAWING

FIG. 1 is a perspective view of a preferred embodiment of the present invention. The present invention is used as a highlighter.

FIG. 2 is a perspective view of a preferred embodiment of the present invention. The present invention is used as a pen.

FIG. 3 shows a schematic view of the cross-section of the pen body.

FIG. 4A shows a perspective view of the lower section of the pen body.

FIG. 4B shows a schematic view of the cross-section of the lower section of the pen body.

FIG. 5A shows a perspective view of the pen cap when the pen cap is in an open position.

FIG. 5B shows a perspective view of the pen cap when the pen cap is in closed position.

FIG. 6A shows a schematic view of the cross-section of a preferred embodiment of the present invention, showing the present invention is used as a pen.

FIG. 6B shows another schematic view of the cross-section of a preferred embodiment of the present invention.

FIG. 6C shows another schematic view of the cross-section of a preferred embodiment of the present invention, showing the highlighter is in use position.

FIG. 7 is a perspective view of another preferred embodiment of the present invention. The present invention is used as a highlighter.

FIG. 8 is a perspective view of another preferred embodiment of the present invention. The present invention is used as a pen.

FIG. 9 is a perspective view of another preferred embodiment of the present invention. The present invention is used as a pencil.

FIG. 10A is a perspective view of another preferred embodiment of the present invention when the pen cap is in closed position.

FIG. 10B is a perspective view of another preferred embodiment of the present invention when the pen cap is stored on the pen.

FIG. 11 is a perspective view of another preferred embodiment of the present invention, showing how to seal the present invention with a pen cap.

FIG. 12A is a perspective view of another preferred embodiment of the present invention, without a pen cap attached to it.

FIG. 12B is a perspective view of another preferred embodiment of the present invention, with a pen cap attached to it.

### DETAILED DESCRIPTION OF THE PRESENT INVENTION

The present invention integrates the functions of a pen, a pencil, and a highlighter into one device. It also comprises a seal system that prevents volatile marking substances in the cartridge of the highlighter from evaporating.

### Preferred Embodiment

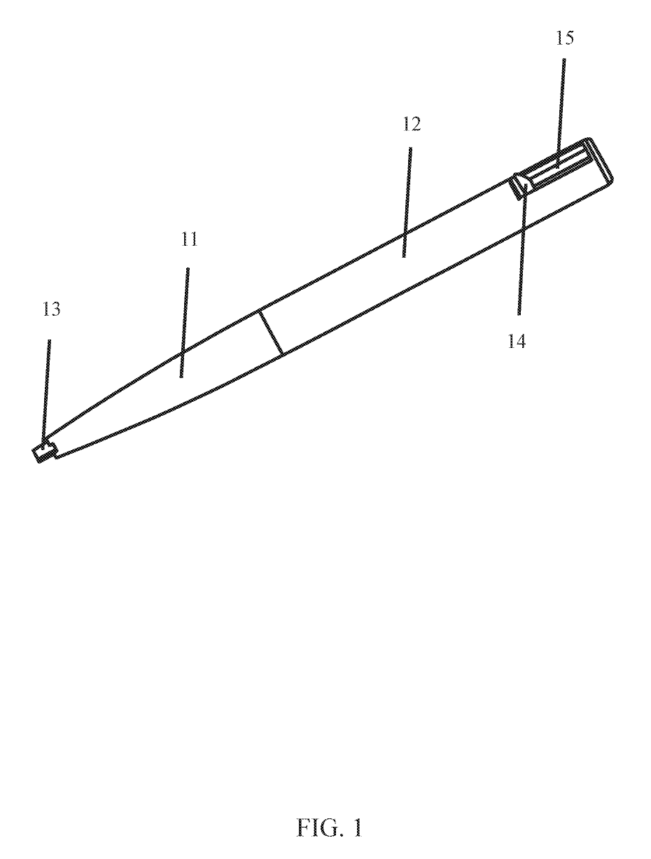

FIG. 1 is a perspective view of a preferred embodiment of the present invention. It shows that the present invention has two sections: a lower section 11 and an upper section 12. When the function button for a highlighter 14 is slid along the slot 15 toward the lower section 11, the highlighter tip 13 protrudes from the lower section 11. Then, the invention can be used as a highlighter.

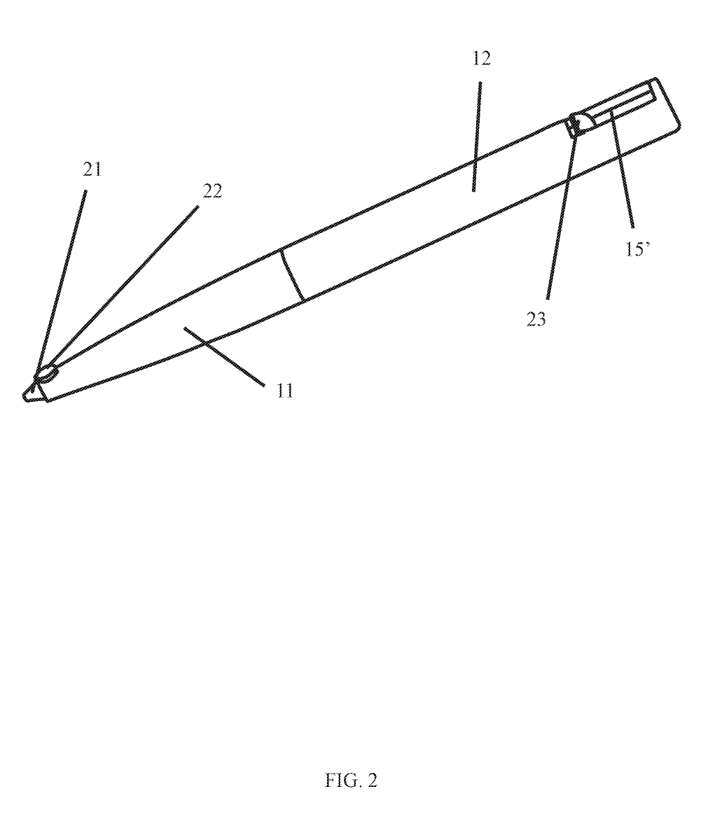

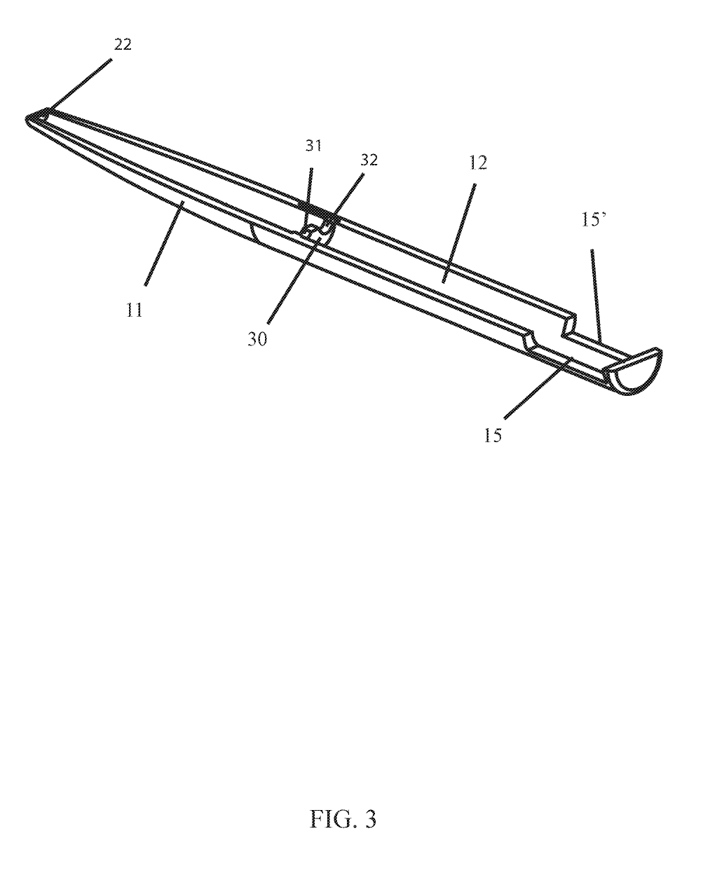

FIG. 2 is another perspective view of the preferred embodiment of the present invention. It shows that when the function button for a pen 23 is slid along the slot 15′ toward the lower section 11, a pen tip 21 protrudes from the lower section 11. The invention then can be used as a pen. In FIG. 2, the small round piece 22 is a pen cap. It is used to prevent the volatile substance in the highlighter from evaporating quickly. This can be better understood through FIGS. 3, 4 and 5.

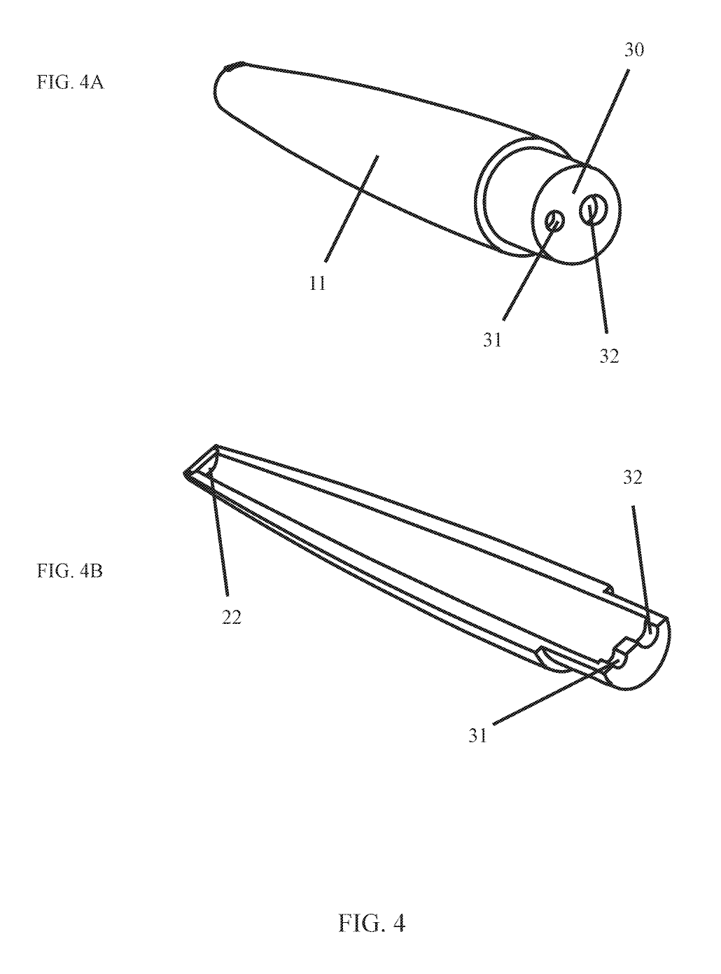

FIG. 3 is a perspective view of a cross-section of the pen body. It shows that an object 30 separates the pen body into two sections: a lower section 11, and an upper section 12. On the object 30, there are a small hole 31 and a large hole 32. The diameter of the small hole 31 is equal to the diameter of the cartridge of the pen, and the diameter of the large hole 32 is equal to the diameter of the cartridge of the highlighter. In FIG. 3 the cap 22 is in its closed position. The function of the object 30, holes 31 and 32, and the cap 22 can be better understood through FIG. 4.

FIG. 4 shows enlarged perspective views of the lower section 11. At the large end of the lower section 11 is the object 30 having two holes 31 and 32 (FIG. 4A), and at the small end of the lower section 11 is the cap 22 in the closed position (FIG. 4B, a cross-section view). When the cartridges of a pen and highlighter are inserted in the holes 31 and 32, the lower section 11 is sealed. No volatile substance in the cartridges can escape the lower section 11, which prevents the highlighter from drying fast.

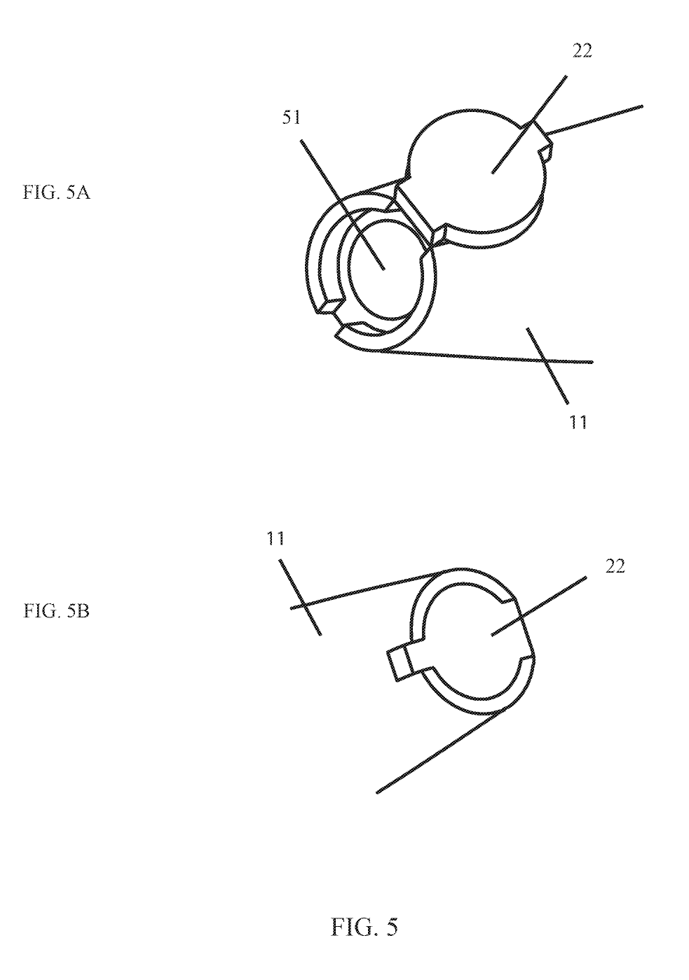

FIG. 5 shows enlarged perspective views of the small end of the lower section 11. FIG. 5A shows the cap 22 is attached to lower section 11 at the edge. Since the cap 22 is attached to the pen body, a user does not have to worry about losing the cap 22 when he or she uses the present invention. FIG. 5B shows that when the cap 22 in its closed, it seals the hole 51, preventing the highlighter from drying.

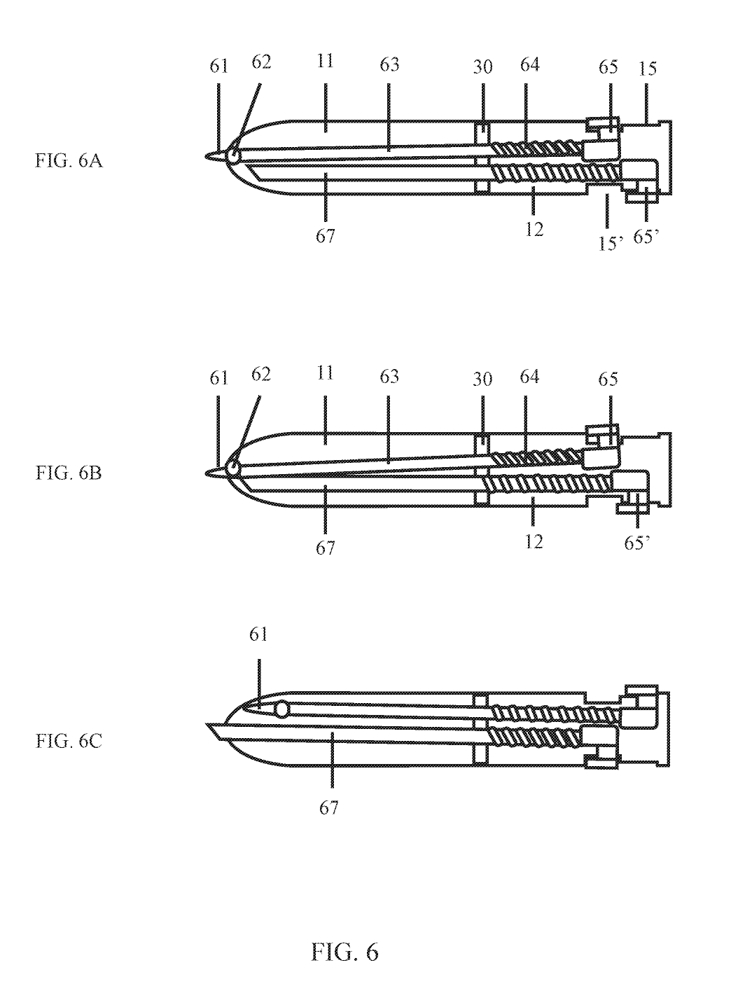

FIG. 6 shows schematic drawings of the cross-section of the preferred embodiment of the present invention. FIG. 6A shows that when the present invention is used as a pen, the seal ring 62 attached to the pen cartridge 63 is pressed against the hole at the small end of the lower section 11. Since the outer diameter of the seal ring 62 is slightly larger than the diameter of the opening 51 (FIG. 5), the seal ring 62 prevents volatile substances of the highlighter 67 from evaporating. If a user wants to use the present invention as a highlighter, all he or she needs to do is to slide the highlighter function button 65′ toward the small end of the lower section 11. When the highlighter function button 65′ touches the pen function button 65, it pushes the pen function button 65 upward, as shown in FIG. 6B. Under the force of the spring 64, the pen tip 61 retracts into the lower section 11, allowing the highlighter 67 to protrude from the hole of the pen body, as shown in FIG. 6C.

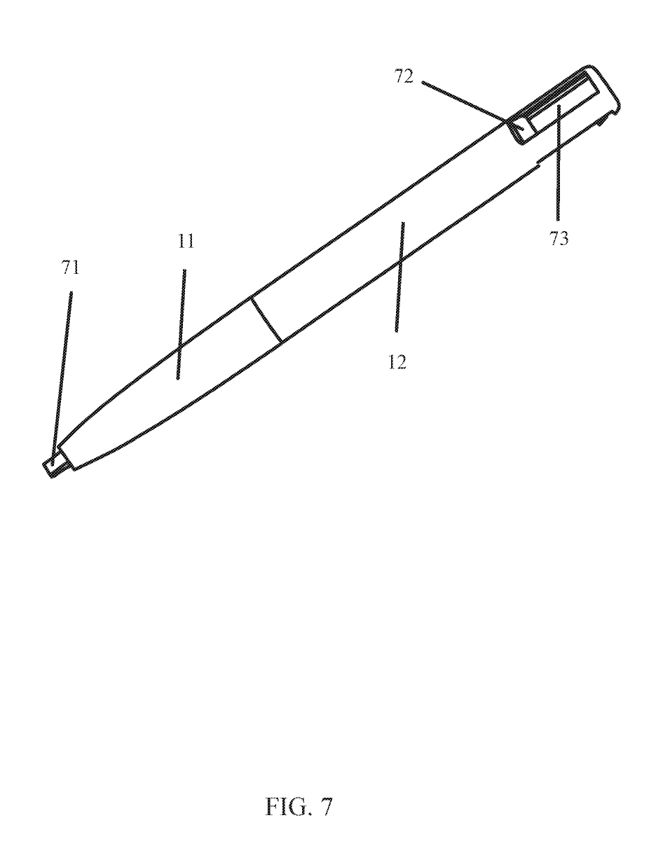

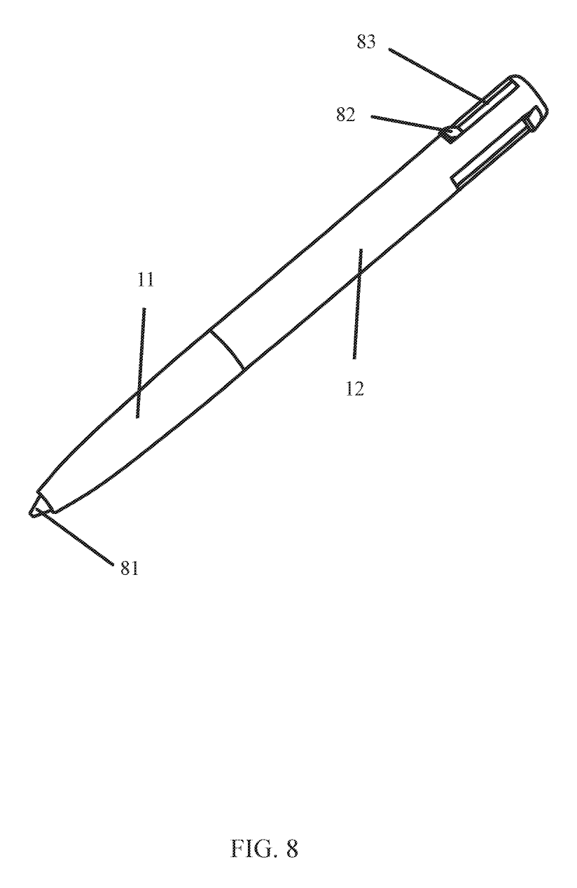

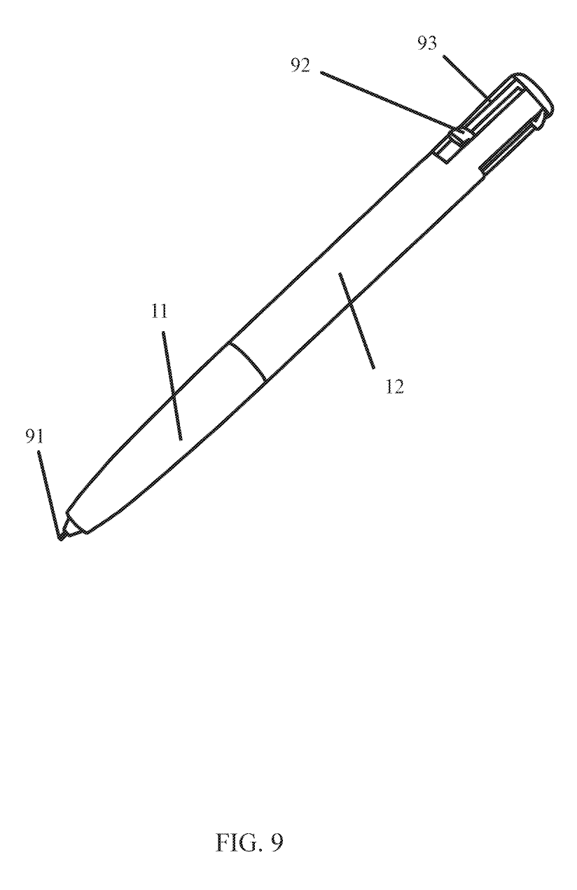

The preferred embodiment is presented for an illustrative purpose and is not intended to limit the scope of the present invention. Other modifications can be undertaken by a skilled artisan, without departing from the spirit and scope of this invention. For example, the present invention can integrate the functions of a pen, a highlighter, and a pencil in a single pen body. FIGS. 7, 8, and 9 are perspective views of the present invention. FIG. 7 shows that when the highlight function button 72 is slide along the slot 73 toward the lower section 11, the highlighter tip 71 protrudes from the lower section 11. FIG. 8 shows that when the pen function button 82 is slide along the slot 83 toward the lower section 11, the pen tip 81 protrudes from the lower section 11. FIG. 9 shows that when the pencil function button 92 is slide along the slot 93 toward the lower section 11, the pencil tip 91 protrudes from the lower section 11.

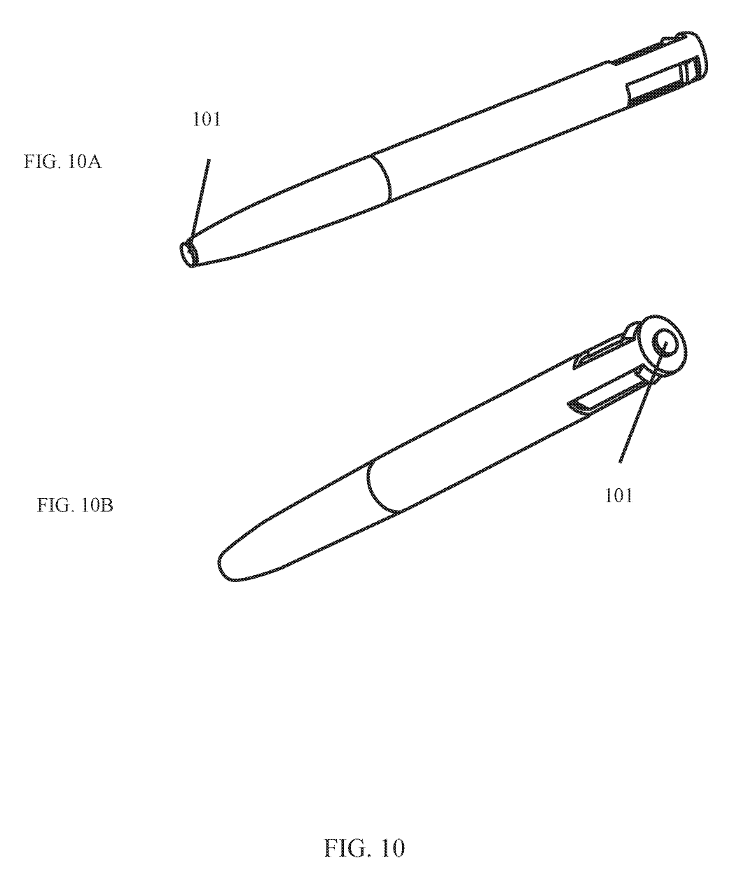

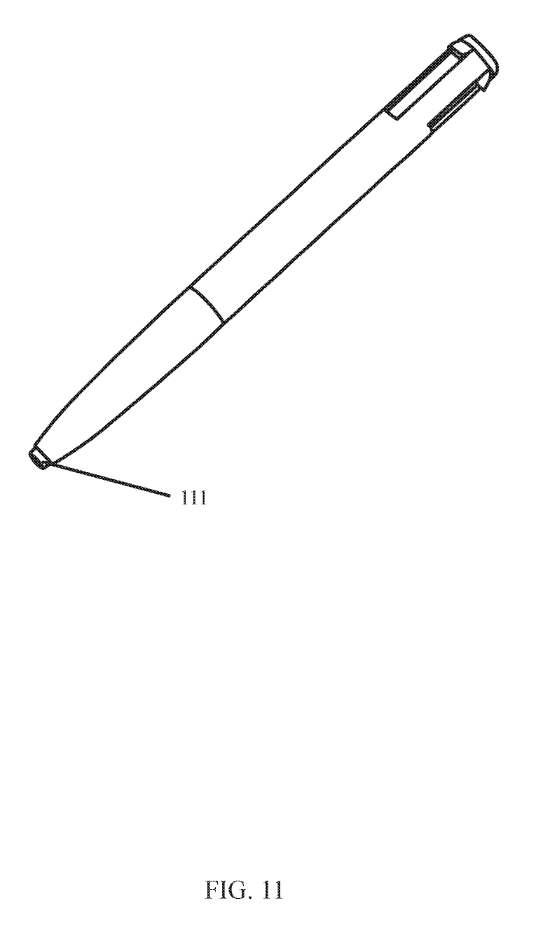

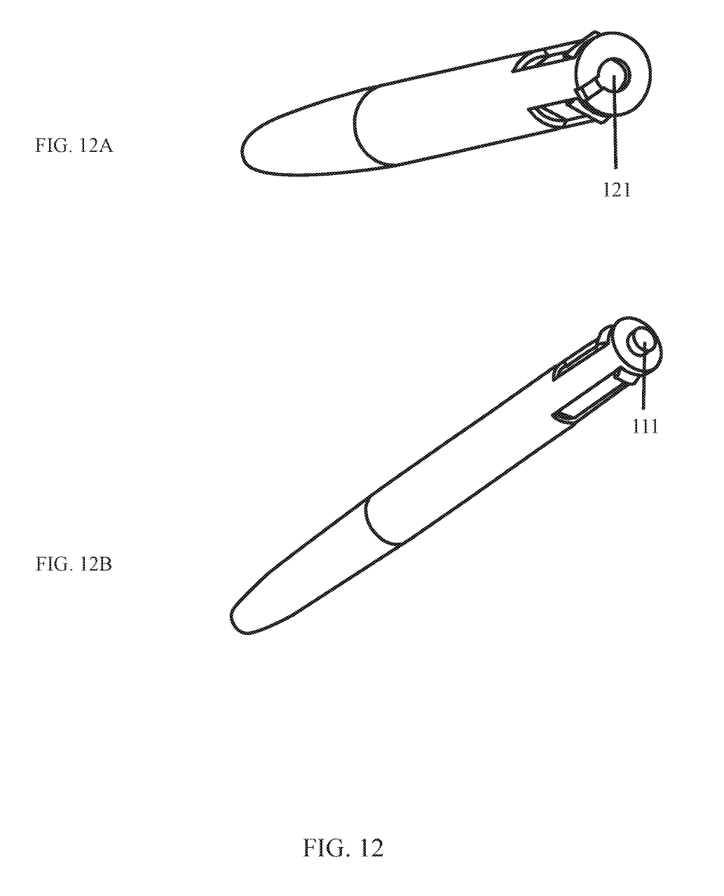

Also a pen cap of the present invention does not have to be attached to the lower section 11, as shown in FIG. 5A. FIG. 10A shows a magnetic cap 101 is placed at the small end of the pen body that contains metal to seal the pen body. FIG. 10B shows the magnetic cap 101 is placed on the large end of the pen body that also contains metal to prevent it from getting lost. The pen cap of the present invention can be made of various materials. In FIG. 11, the pen cap 111 is an eraser. When a person wants to use the present invention, he or she unplugs the cap 111 and then inserts it into the recess 112 at the other end of the pen body (FIG. 12A). The pen cap then can serve as an eraser as shown in FIG. 12B.

I claim:

1. A multifunction pen that can be used as a pen, or a pencil, or a highlighter, comprising:
an elongated pen body comprising an elongated upper section and an elongated lower section, wherein said lower section has a large end with at least two holes on its surface and a small end with at least one hole on its surface;
a plurality of cartridges in said pen body, wherein said cartridges may contain volatile substances, wherein the diameters of said cartridges are the same as the diameters of said holes on said surface at said large end of said lower section of said pen body, whereby when said cartridges are placed in said holes, said holes are sealed airtight by said cartridges, preventing air exchange between said upper section and said lower section of said pen body; and
a cap that is attached to the edge of said small end of said lower section of said pen body, wherein said cap can rotate along said edge, whereby said cap can seal said hole on said small end of said low section of said pen body to prevent said volatile substances from evaporating through said hole on said small end.

2. A multifunction pen that can be used as a pen, or a pencil, or a highlighter, comprising:
an elongated pen body comprising an elongated upper section and an elongated lower section, wherein said lower section has a large end with at least two holes on its surface and a small end with at least one hole on its surface, wherein said small end contains metal or magnetic;
a plurality of cartridges in said pen body, wherein said cartridges may contain volatile substances, wherein the diameters of said cartridges are the same as the diameters of said holes on said surface at said large end of said lower section of said pen body, whereby when said cartridges are placed in said holes, said holes are sealed airtight by said cartridges, preventing air exchange between said upper section and said lower section of said pen body; and
a magnetic cap having a diameter about the same as the diameter of said hole at said small end of said lower section of said pen body, whereby said magnetic cap can seal said hole on said small end of said low section of said pen body to prevent said volatile substances from evaporating through said hole on said small end.
